(19) United States
(12) Patent Application Publication
(10) Pub. No.: US 2026/0277933 A1
(43) Pub. Date: Sep. 17, 2026

(54) TOPICAL CLUSTER HIERARCHY

(71) Applicant: Microsoft Technology Licensing, LLC, Redmond, WA (US)

(72) Inventors: Ge WANG, Sammamish, WA (US); Pak On CHAN, Seattle, WA (US); Deepika PURI, Syosset, NY (US); Andy NGUYEN, Seattle, WA (US); Vinayak NADIR, New Delhi (IN); Ghazal MAZAHERI, Santa Monica, CA (US); Milenko DRINIC, Kenmore, WA (US); Samuel Johnson SHELTON, Kirkland, WA (US); Sundar KAMESWARAN, Redmond, WA (US); Nicholas James ROBINSON, Redmond, WA (US); Ramya KONERU, San Jose, CA (US); Annapurna Lakshmi SARIPALLI, Hyderabad (IN); Chen XU, Lynnwood, WA (US); Kai LIANG, Bellevue, WA (US); Israa Qasim JARADAT, Boise, ID (US); Pankaj Jitendra PARIKH, Snohomish, WA (US); Michael RAWSON, Seattle, WA (US); Maxim NACU, Redmond, WA (US); Venkata Rao SALADI, Redmond, WA (US)

(21) Appl. No.: 19/193,420

(22) Filed: Apr. 29, 2025

(30) Foreign Application Priority Data
Mar. 13, 2025 (IN) 202511022922

(51) Int. Cl. G06F 16/28

(52) U.S. Cl. CPC G06F 16/285

(57) ABSTRACT

A topical cluster hierarchy (TCH) is constructed by recursive subclustering of document clusters until a termination condition is detected. The clusters have centroids of topic proximity with respect to at least one user-specified topic. Subclustering starts after thresholds of minimal cluster topic proximity or minimal cluster coherence are met, thus avoiding processing of low-utility clusters. Subclustering terminates when sufficient topic proximity, coherence, or cluster depth is reached. A tool utilizes the TCH to control topic-directed searching, topic-directed filtering, analyzing, summarizing, or categorizing, of documents.

### RELATED APPLICATION

The present application claims priority to, and incorporates by reference the entirety of, India provisional patent application number 202511022922 filed 13 Mar. 2025.

### BACKGROUND

In computing, text processing supports or performs operations which analyze, categorize, create, edit, filter, format, generate a report, search, search and replace, simplify, summarize, or translate, or other operations. The text being processed often includes natural language text, but in some scenarios the text also or instead includes programming language source code or other artificial language text. Text processing as understood herein includes, but is not limited to, computational operations with text in scenarios including databases, artificial intelligence mechanisms, natural language processing, or combinations thereof.

### SUMMARY

Some topical cluster hierarchy embodiments address technical challenges arising from inflexible, unstable, or arbitrary document categorization efforts. One challenge is how to improve clustering efficiency when dividing a corpus of documents into clusters according to one or more topics. Another challenge is how to improve clustering effectiveness without obscuring nuances and subtle relationships, themes, or keywords. Other technical challenges of document categorization by topic are also addressed herein.

One example embodiment of topical hierarchical clustering taught herein obtains some initial clusters which represent documents of a corpus, calculates a respective centroid of each of the clusters, determines a respective topic proximity score for each of the centroids representing a proximity of the centroid and its corresponding cluster to a specified topic, constructs a cluster hierarchy by recursively specifying a subcluster of one of the clusters until a termination condition is detected, and utilizes the cluster hierarchy to control at least one of: topic-directed searching of the corpus, topic-directed filtering of the corpus, analyzing at least a portion of the corpus, summarizing at least a portion of the corpus, or categorizing at least a portion of the corpus. This embodiment improves clustering efficiency by dynamically identifying and focusing on clusters that align with a specific topic while not expending resources on off-topic documents, thereby reducing machine operations such as CPU cycles to get to a result, user interface processing, network communications, database accesses, and security risks. This embodiment improves clustering effectiveness by permitting a fine granularity when segmenting and grouping content. Instead of relying on broad, high-level categories that obscure important nuances, the embodiment organizes documents into smaller, more focused clusters.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description is given with reference to the attached drawings. These drawings only illustrate selected aspects and thus do not fully determine coverage or scope.

FIG. 1 is a diagram illustrating aspects of computer systems, including some aspects generally suitable for enhanced systems which include or use topical cluster hierarchy (TCH) functionality;

FIG. 2 is a block diagram illustrating aspects of a first example family of enhanced systems which are each configured with TCH functionality;

FIG. 3 is a dataflow diagram of a second example family of enhanced systems which are each configured with TCH functionality;

FIG. 4 is a hierarchy diagram illustrating aspects of a first topical hierarchical clustering, also referred to as a topical clustering hierarchy;

FIG. 5 is a hierarchy diagram illustrating some aspects of a second topical clustering hierarchy;

FIG. 6 is a hierarchy diagram illustrating some additional aspects of the second topical clustering hierarchy;

FIG. 7 is a hierarchy diagram illustrating aspects of a third topical clustering hierarchy;

FIG. 8 is a cluster diagram illustrating use of an average vector as a centroid;

FIG. 9 is a cluster diagram illustrating use of a document as a centroid;

FIG. 10 is a block diagram illustrating some aspects and items related to topical clustering;

FIG. 11 is a first flowchart illustrating some TCH methods;

FIG. 12 is a second flowchart illustrating some TCH methods;

FIG. 13 is a third flowchart illustrating some TCH methods; and

FIG. 14 is a fourth flowchart further illustrating TCH methods, and incorporating as options the steps of each of FIG. 11 through FIG. 13, and other steps disclosed herein.

### DETAILED DESCRIPTION

### Overview

Some teachings described herein reflect technical challenges faced and insights gained during efforts to improve search tools or categorization tools. However, the teachings herein are not limited in their scope or applicability to this particular kind of software, or to these particular challenges, solutions, or insights, or to the particular application fields used as examples.

In the field of cybersecurity generally and particularly the field of cybersecurity incident investigations, it is sometimes helpful to categorize various kinds of documents, e.g., source code files, vulnerability identification tool outputs, human-created reports, tool-generated reports, network packets, configuration files, directory listings, and so on. Other fields involve other kinds of documents, ranging in size from a short social media post to a product review to a blog entry to a technical paper to a book, for example, depending on the field and the scenario.

One approach to the problem of categorizing documents is unsupervised clustering. Given a corpus of documents, a clustering algorithm such as K-means or K-medioid groups documents into clusters according to the similarity of the documents' contents. However, the specific inclusion or exclusion criteria employed by the algorithm to define a given cluster is sometimes unclear. Moreover, the clusters created by the algorithm are not necessarily the clusters of greatest utility to a user. For instance, clusters defined according to which operating system is mentioned most in a document provide little help when investigating differences or similarities between incidents involving different network protocols. But if operating system names occur more frequently in the corpus than network protocol names, then cluster boundaries are likely to correlate much more with operating system differences than with network protocol differences.

Some embodiments described herein take a different approach, referred to here as topical cluster hierarchy (TCH). These embodiments obtain an initial plurality of clusters, by accessing pre-existing clusters, or creating clusters, or both. This is an “initial” plurality in the sense that in some scenarios additional clusters are created by subclustering. Each cluster includes a data structure which represents multiple documents of a corpus; calculate a respective centroid of each of the clusters; determine a respective topic proximity score for each of the centroids, the topic proximity score representing a proximity of the centroid and its corresponding cluster to a specified topic; construct a cluster hierarchy by recursively specifying a subcluster of one of the clusters until a termination condition is detected; and utilize at least the cluster hierarchy to control at least one of: topic-directed searching of the corpus, topic-directed filtering of the corpus, analyzing at least a portion of the corpus, summarizing at least a portion of the corpus, or categorizing at least a portion of the corpus.

This TCH functionality has a technical benefit of improving security by categorizing documents that contain sensitive content without human review, or with reduced human review compared to traditional unsupervised clustering. This TCH functionality also provides a highly efficient method for handling large-scale data clustering by dynamically identifying and focusing on clusters that align with specified topics, as opposed to topics selected by K-means or K-medioid and term frequency.

In some TCH embodiments, constructing a cluster hierarchy includes ranking two clusters according to at least the topic proximity scores of the respective centroids of the two clusters; and prioritizing subclustering of the cluster which is ranked as the more proximate of the two clusters.

This TCH functionality beneficially enhances the effectiveness of document clustering by employing a finer granularity in segmenting and grouping content than some traditional clustering. Instead of relying on broad, high-level categories that can obscure important nuances, the TCH functionality organizes documents into smaller, more focused clusters which are more proximate to the topic(s) specified by the user.

In some TCH embodiments, the termination condition includes at least one of: a remoteness score threshold, a topic proximity score threshold, a maximum depth allowed for the cluster hierarchy, a cluster coherence threshold of a cluster coherence score representing similarity between documents, or a cluster incoherence threshold.

This TCH functionality has a technical benefit of improving computational efficiency. Clusters that do not meet the remoteness score (or the incoherence score when it is used) are marked as non-essential and remain at a higher, coarser level of categorization. Clusters that do meet the remoteness score (and the incoherence score when it is also used) are subclustered to produce more tightly focused clusters. Multilevel topic-focused clustering improves effective identification of subtle relationships, themes, or keywords that might otherwise go undetected in a coarser-grained approach. This selective approach reduces computational overhead and processing time, as the embodiment avoids the extra effort and cost of producing fine-grained subclusters in areas that offer limited value to the user, while it prioritizes document clusters that focus on pertinent (topically proximate) content. Efficiency is also gained by terminating subclustering when sufficient proximity or coherence is reached, or when going deeper would cost too much. As a result, embodiments reduce machine operations such as CPU cycles to get to a result, user interface processing, network communications, database accesses, and security risks.

In some TCH embodiments, the method includes determining multiple topic proximity scores for each of the centroids, each topic proximity score representing a proximity of the centroid to a respective specified topic; and the termination condition is computed at least in part from the multiple topic proximity scores.

This TCH functionality has a technical benefit of improving effectiveness and accuracy by defining at least one cluster which is focused on two or more topics specified by the user. This allows the identification of subtle relationships, correlated themes, or keyword combinations that might otherwise go undetected in a single-topic-per-cluster approach or an algorithm-selected-topic approach.

In some TCH embodiments, determining the respective topic proximity score for a centroid includes: submitting to a language model a description of the centroid and a description of the topic, with a prompt to produce the topic proximity score; and in response receiving the topic proximity score from the language model.

This TCH functionality has a technical benefit of improving accuracy and effectiveness by leveraging language model capabilities to assess proximity of a cluster (as represented by the centroid) to a user-specified topic. Language models sometimes detect topic proximity that is not apparent from keyword comparisons alone, when the language model's training data correlates items that do not contain the same keyword.

In some TCH embodiments, a computing system includes multiple processing nodes, and further includes instructions which upon execution by the processor partition the corpus into multiple corpus portions, and allocate a plurality of the corpus portions to respective processing nodes.

This TCH functionality has a technical benefit of improving scalability and decreasing processing wall-clock time. Such an embodiment employs a distributed clustering framework to evenly balance processing tasks across multiple nodes or servers. Rather than concentrating data analysis on a single machine, it partitions large data sets and allocates them to different nodes. This parallelization effectively prevents any single node from becoming a bottleneck, improving both speed and scalability as the volume of incoming data grows.

These and other advantages and benefits will be apparent to one of skill from the teachings provided herein.

### Operating Environments

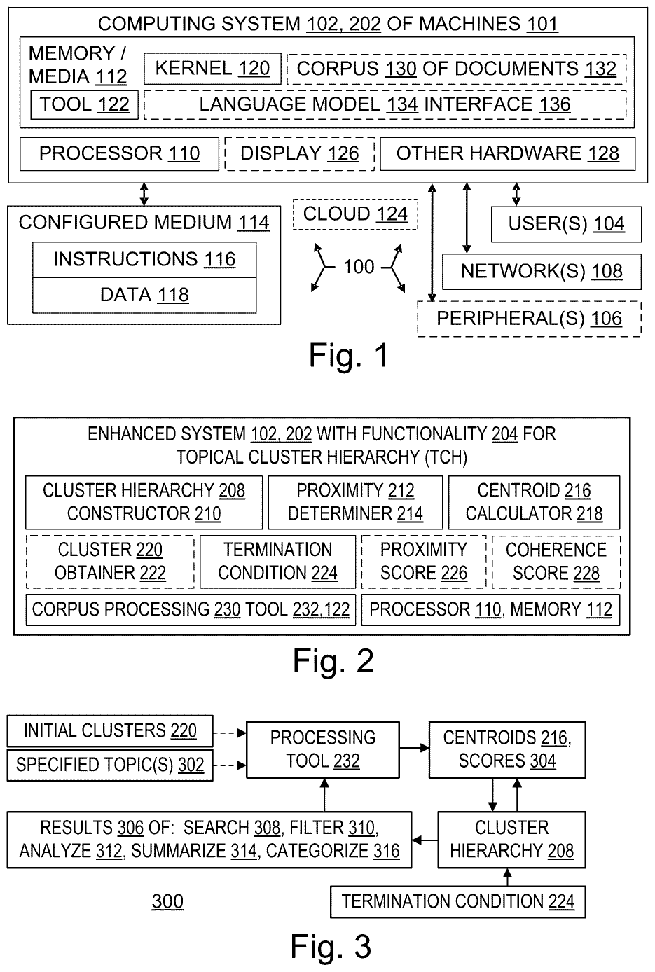

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and integral parts of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, editors, compilers, debuggers and other software development tools, document processing tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, physical measurements, sensor data, and so forth.

Although an embodiment may include software instructions executed by one or more processors in a computing device (e.g., general purpose computer, server, or cluster), such description is not meant to exhaust all possible embodiments. Embodiments do not necessarily include any software. One of skill will understand that the same or similar functionality of software can often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one or more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) are present in operable communication with one or more processors 110 and memory 112.

In some embodiments or operating environments, a system includes multiple computers connected by a wired and/or wireless network 108. Networking interface equipment 128 provides access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected from, or only intermittently connected to, another networked device or remote cloud or the internet. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings do not provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be properly added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment, which are disclosed herein but not tied to a particular reference numeral. Corresponding drawings may also be properly added.

More about TCH Systems

Specific items called out in the figures are discussed at various points herein. FIG. 2 illustrates a computing system 102 or other system configured by one or more of the TCH functionality enhancements taught herein, resulting in an enhanced system 202. In some embodiments, an enhanced system 202 includes a single machine (computational or not), a local network of machines, machines in a particular building, machines used by a particular entity, machines in a particular datacenter, machines in a particular cloud, or another environment 100 that is suitably enhanced as taught herein.

FIG. 3 is a dataflow diagram 300 of another example family of enhanced systems 202 which are each configured with TCH functionality 204. In some embodiments consistent with FIG. 3, components shown in FIG. 2 or other figures are also present.

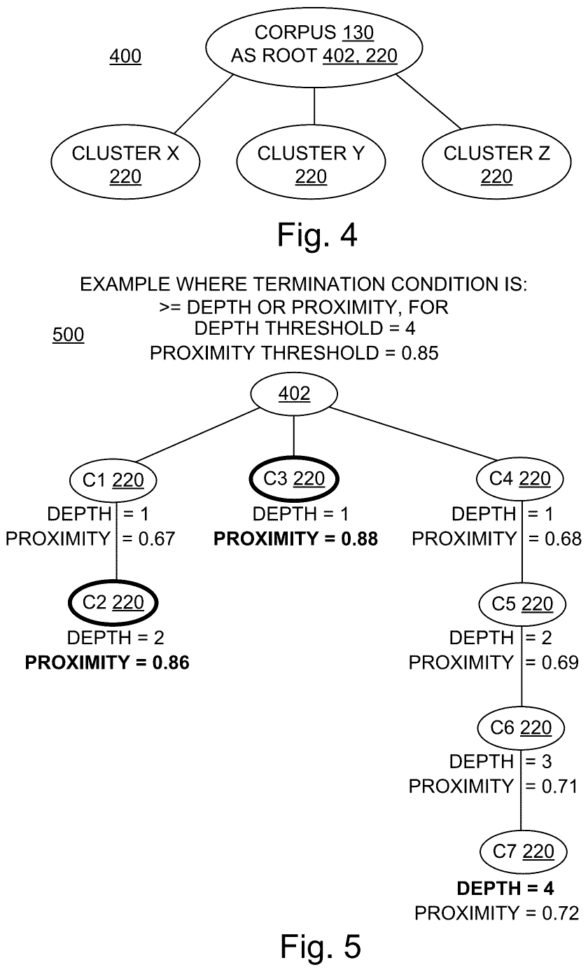

FIG. 4 illustrates a cluster hierarchy 400, which includes a root 402 and three clusters 220 named X, Y, and Z, respectively. In this example, the entire corpus 130 is treated for computational and conceptual convenience as a cluster, which is also the root cluster of the hierarchy 400, 208. For instance, this treatment facilitates depth calculation by making it clear that X, Y, and Z are each at depth=1 in the same hierarchy as one another. X is also a root of a subtree (hence at depth 0 in that subtree), Y and Z are each similarly the root of another respective subtree.

In many embodiments, the data structure 1004 representing a cluster 220 under a root 402 will be structured the same for each such cluster, albeit with different values for different clusters. Cluster data structure fields include, e.g., the documents 132 (e.g., pointers, indexes, etc.), the centroid 216 (if calculated, null otherwise), a parent pointer, zero or more child pointers, depth 1010 (if stored explicitly rather than computed on-the-fly), topic proximity 226, coherence 228 (in embodiments that track coherence), and a cluster identifier. Topic proximity and coherence are scored, e.g., by a language model or statistical analysis software. A coherence determiner 1066 calculates, e.g., a silhouette score 228 or an average similarity score 228. The same data structure is used to represent the root 402 in some embodiments, while in other embodiments a simpler root-specific data structure 1004 is used, which omits one or more of the following data structure fields: coherence, topic proximity, depth, parent pointer, and centroid.

FIG. 5 illustrates an example TCH scenario with a subclustering termination condition 224 which is dependent on depth and topic proximity; cluster coherence is not part of the termination condition in this example. A topic proximity threshold 1002 is specified, so a sufficiently high cluster topic proximity will terminate subclustering, but a remoteness threshold 1054 is not specified, so subclustering is permitted for any of the initial clusters C1, C3, C4. Subclustering in the subtree rooted at cluster C1 terminated at leaf cluster C2 because the topic proximity of C2 (0.86) is at least as great as the topic proximity threshold (0.85). Subclustering in the subtree rooted at cluster C3 terminated immediately (C3 is also a leaf of the subtree) because the topic proximity of C3 (0.88) is at least as great as the topic proximity threshold (0.85). Subclustering in the subtree rooted at cluster C4 terminated at leaf cluster C7 because the depth at C7 is at least as great as the depth threshold (4). Clusters C2 and C3 are output for utilization 1110 as clusters whose documents are sufficiently topic proximate, because the topic proximity of C2 and the topic proximity of C3 is at least as great as the topic proximity threshold. Although C7 is a leaf cluster, C7 is not output as a cluster whose documents are sufficiently topic proximate, because the topic proximity of C7 is not at least as great as the topic proximity threshold.

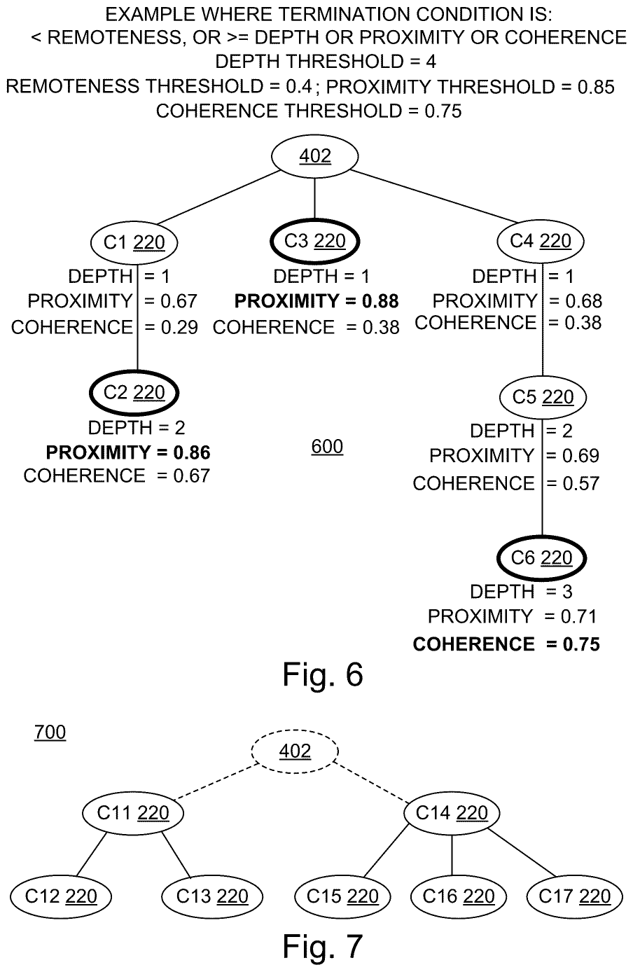

FIG. 6 illustrates an example TCH scenario with a subclustering termination condition 224 which is dependent on depth and topic proximity and cluster coherence. Moreover, a remoteness threshold 1054 is part of the termination condition in this example. Each of the initial clusters C1, C3, C4 has a topic proximity at least as great as the remoteness threshold (0.4), so subclustering is permitted for any of them. As in the FIG. 5 example, subclustering in the FIG. 6 subtree rooted at cluster C1 terminated at leaf cluster C2 because the topic proximity of C2 (0.86) is at least as great as the topic proximity threshold (0.85). Unlike FIG. 5, the FIG. 6 scenario also tracks cluster coherence; in a variation where the termination condition involves topic proximity AND coherence instead of topic proximity OR coherence, subclustering would not have terminated at C2 because C2 coherence (0.67) is not sufficient (it is below 0.75). As in the FIG. 5 example, subclustering in the FIG. 6 subtree rooted at cluster C3 terminated immediately (C3 is also a leaf of the subtree) because the topic proximity of C3 (0.88) is at least as great as the topic proximity threshold (0.85). In a variation where the termination condition involves topic proximity AND coherence instead of topic proximity OR coherence, subclustering would not have terminated at C3 because C3 coherence (0.38) is not sufficient (it is below 0.75). Subclustering in the FIG. 6 subtree rooted at cluster C4 terminated at leaf cluster C6 at depth 3, in response to sufficient coherence, unlike the FIG. 5 termination at C7 due to the max depth of 4. Clusters C2, C3, and C6 are output for utilization 1110 as clusters whose documents are sufficiently topic proximate or sufficiently coherent or both.

FIGS. 5 and 6 are not comprehensive, but are merely examples. Some of the ways other scenarios may depart from these examples while still being consistent with TCH functionality 204 and teachings herein include: different values for the thresholds, different numbers of children created by subclustering, and different Boolean or other computational combinations of items (topic proximity, remoteness, coherence, incoherence, depth, or max/min documents per leaf cluster) in a termination condition.

FIG. 7 illustrates a hierarchy 700 which differs from the examples in FIG. 5 and FIG. 6 in various ways. One notable difference is the presence of multiple sibling children of cluster C11 and cluster C14. For simplicity of illustration and discussion, the FIG. 5 and FIG. 6 examples had at most one child per cluster, but the teachings herein are also beneficially applicable to scenarios in which a cluster has multiple sibling children. Another difference is that root 402 is shown in dashed lines in FIG. 7, to emphasize that in some embodiments the root 402 is represented by a different data structure than the data structure which represents the initial clusters and the generated subclusters.

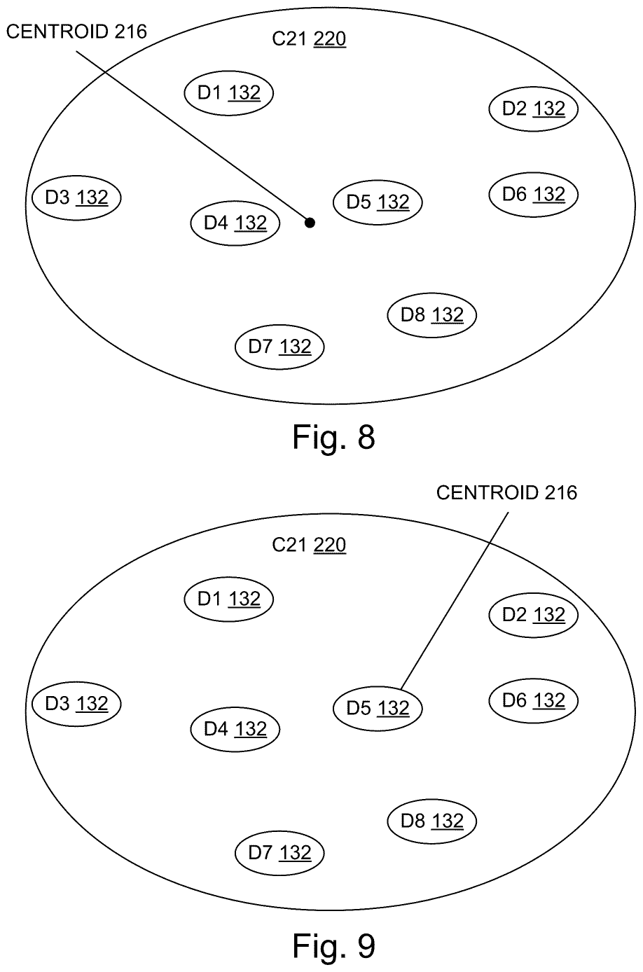

FIG. 8 and FIG. 9 illustrate different definitions of a cluster centroid 216. In FIG. 8, an average of the vectors representing the documents D1 . . . D8 serves as the centroid. In FIG. 9, a particular one of the documents 132, namely D5, which is closest to the average vector of the document vectors, serves as the centroid. Vectors are obtained from vectorizers 1068, e.g., word2vec, countvectorizer, text-embedding-ada-002, or other software 1068 which creates embedding space vectors from text.

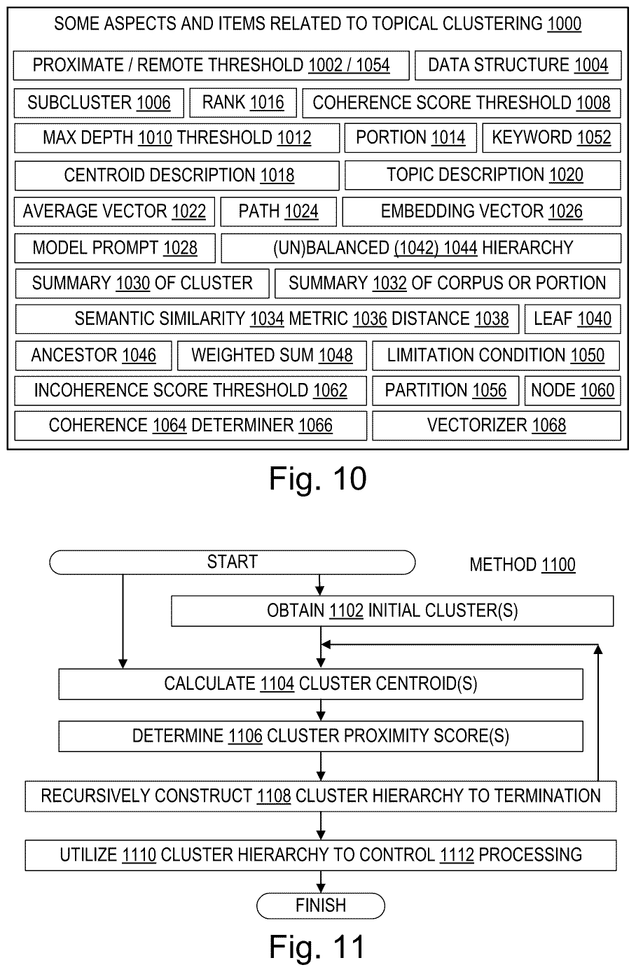

FIG. 10 shows reference numerals for some items and some aspects of items that relate to TCH. Failure to receive a reference numeral does not make an item insignificant.

FIGS. 1-10 do not individually or collectively or in any subset fully define a comprehensive summary of all aspects of enhanced systems 202 or all aspects of TCH functionality 204. Nor is any figure of FIGS. 1-10 or any group of figures of FIGS. 1-10 by itself a comprehensive summary of all aspects of an environment 100 or another context of an enhanced system 202.

The other figures are also pertinent to systems 202. FIGS. 11 to 14 are flowcharts which illustrate some methods of TCH functionality 204 operation in some systems 202.

In some embodiments, the enhanced system 202 is networked through an interface 1060. In some, an interface 1060 includes hardware such as network interface cards, software such as network stacks, APIs, or sockets, combination items such as network connections, or a combination thereof.

Some embodiments include a computing system 202 which is equipped, structured, or otherwise configured to utilize or provide TCH functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous address block or of a single kind, e.g., a memory 112 may include hard drive memory as well as volatile RAM, and may include memories that are physically located on different machines 101, but “memory” alone also includes systems with multiple memories. Similarly, the phrase “processor set” is used to emphasize that a processor 110 is not necessarily confined to a single chip or a single machine 101, but “processor” alone also includes systems with multiple processors.

All sets herein are non-empty unless described otherwise. At a given point in time any data structure implementing a set identified in this description is empty, or is non-empty, depending on the embodiment and the circumstances. However, even an empty set is defined and detectable in the system 202 as a set when an embodiment includes a data structure implementing the set. The absence of members of a set is not the absence of the set itself.

In this example, a computing system 202 includes at least one processor 110, which is in operable communication with at least one digital memory 112. The at least one digital memory includes volatile storage and non-volatile storage unless indicated otherwise.

Some embodiments include a computing system 202 including: a digital memory 112; a processor 110 in operable communication with the digital memory; a cluster obtainer 222 including instructions 116 which upon execution by the processor obtain 1102 an initial plurality of clusters 220 by accessing pre-existing clusters or creating clusters or both, each cluster including a data structure 1004 which represents multiple documents 132 of a corpus 130; a centroid calculator 218 including instructions 116 which upon execution by the processor calculate 1104 a respective centroid 216 for each of the clusters; a topic proximity determiner 214 including instructions 116 which upon execution by the processor determine 1106 a respective topic proximity score 226 for each of the centroids, the topic proximity score representing a proximity of the centroid to a specified topic 302; a hierarchy constructor 210 including instructions 116 which upon execution by the processor constructs 1108 a cluster hierarchy 208 by recursively specifying 1306 a subcluster 1006, 220 of one of the clusters until a termination condition 224 is detected 1402; and a corpus processing tool 232, 122 including instructions 116 which upon execution by the processor utilize 1110 at least the cluster hierarchy to control 1112 at least one of: topic-directed searching 308 of the corpus, topic-directed filtering 310 of the corpus, analyzing 312 at least a portion of the corpus, summarizing 314 at least a portion of the corpus, or categorizing 316 at least a portion of the corpus.

Recursive construction 1108 of a subcluster (a.k.a. recursive specification, recursive subclustering) involves creation of at least one subcluster. What qualifies as a subcluster depends in part on the starting state, e.g., in FIG. 5, C1, C2, C3 are presumed to be the initial plurality of clusters, so none of them is a subcluster. But in a variation, assume the initial plurality is 402 and C1, in which case C3 and C4 are subclusters of 402. Recursive subclustering 1108 allows—but does not necessarily require—creating more than one depth layer of additional cluster(s). Assume the starting plurality in FIG. 5 is C1, C3, C4, and 402. Then examples of clusters (subclusters) at various depths which are constructed by recursive subclustering include C2 subclustered from C1, and C7, C6, C5 subclustered from their parents as shown, up to C5 subclustered from C4. One or more performances of recursive construction 1108 of a subcluster result in hierarchy 208 construction.

For example, one tool 122 utilizes 1110 the cluster hierarchy to help control 1112 topic-directed searching 308 of the corpus by limiting the search to high-proximity clusters 220, or by starting the search in the highest-proximity cluster, moving next to the next highest-proximity cluster, and so on. This presumes the topic of the search matches, or at least correlates with, a topic 302 which guided clustering. Topics 302 are specified via a user interface, a configuration file, a saved state file, or another mechanism for passing data into an application 122. In some scenarios, a search is terminated after a specified number of results is found, so prioritizing the search according to the clusters will improve search speed and efficiency by avoiding searching less proximate clusters.

Efficient topic-directed filtering 310 similarly is controlled 1112 by prioritizing high-proximity clusters as filter inputs. Efficient topic-directed analysis 312 (e.g., sentiment analysis entity extraction, keyword extraction) similarly is controlled by prioritizing high-proximity clusters as analysis software inputs. Efficient summarization 314 is controlled 1112 by summarizing the centroid document in scenarios like FIG. 9, or by summarizing the N documents nearest the centroid in scenarios like FIG. 8, 1<=N<=5. Clustering results in categorization 316, where each sufficiently proximate or sufficiently coherent leaf cluster corresponds to a category.

In some embodiments, the computing system 202 includes the cluster hierarchy 208 residing in the digital memory 112, the cluster hierarchy is unbalanced 1042, the cluster hierarchy includes a path 1024 from a leaf cluster 1040, 220 to a root 402, the root is a parent of the initial plurality of clusters, the path includes the leaf cluster and at least one ancestor 1046 of the leaf cluster below the root, and the path satisfies 1446 or 1450 at least one of: topic proximity scores 226 monotonically increase 1420 along the path, and the leaf cluster's topic proximity score is greater than the topic proximity score of the cluster that is closest to the root on the path; or cluster coherence scores 228 monotonically increase 1420 along the path, and the leaf cluster's cluster coherence score is greater than the cluster coherence score of the cluster that is closest to the root on the path.

A cluster hierarchy is unbalanced when any final leaf nodes are at different depths, and the cluster hierarchy is balanced when all final leaf nodes are at the same depth. During construction, the hierarchy may change between balanced, unbalanced, and indeterminate balance states. A cluster is final when it has been marked or otherwise designated to prevent it from being subclustered. In FIG. 4, if clusters X, Y, Z are not yet final, then the hierarchy's balance state is indeterminate. If clusters X, Y, Z are each final, then the hierarchy is balanced 1044, with all leaf clusters at depth 1. A similar analysis applies to FIG. 7, dependent on whether the leaf clusters are final. The hierarchies 500 and 600 are each unbalanced 1042.

In some embodiments, the computing system 202 includes instructions 116 which upon execution by the processor incrementally assign 1426 a document 132 of the corpus 130 to a cluster 220 after comparing 1424 the document to the centroid 216 of the cluster under a semantic similarity 1034 metric 1036. Assignment is implemented by updating a list, table, or other data structure containing document identifiers.

In some embodiments, the topic proximity determiner 214 includes at least one of: a language model 134, or an interface 136 to a language model; upon execution retrieves 1428 or creates 1430 a language model prompt 1028 which includes or describes the cluster centroid 216, includes or describes a keyword 1052 extracted 1404 from the cluster, and includes a description 1020 of the topic; and upon execution submits 1406 the prompt to the language model, and in response receives 1408 the topic proximity score from the language model.

In some embodiments, the computing system 202 includes multiple processing nodes 1060, and includes instructions 116 which upon execution by the processor partition 1442 the corpus into multiple corpus portions 1014, and allocate 1444 a plurality of the corpus portions to respective processing nodes. In some embodiments the portions 1014 are partitions 1056 which collectively cover the entire corpus and do not overlap one another.

In some embodiments, upon execution the corpus processing tool 232 instructions 116: subcluster 1306 a first cluster whose topic proximity score is less than a specified topic proximity threshold 1002 and greater than or equal to a specified remoteness threshold 1054; and finalize 1432 a second cluster whose topic proximity score is greater than or equal the specified topic proximity threshold without subclustering the second cluster, wherein finalizing includes marking 1434 the second cluster to prevent subclustering the second cluster.

In some embodiments, finalizing 1432 includes generating 1436 a summary 1030 of the second cluster, e.g., by use of a language model.

In some embodiments, the computing system 202 includes the cluster hierarchy 208 residing in the digital memory, the cluster hierarchy is unbalanced 1042, the cluster hierarchy includes a path 1024 from a leaf cluster 1040, 220 to a root 402, the root is a parent of the initial plurality of clusters, the path includes the leaf cluster and at least one ancestor 1046 of the leaf cluster below the root, and upon execution the corpus processing tool 232 instructions utilize 1110 the cluster hierarchy by at least one of: focusing 1416 a topic-directed search 308 of the corpus on documents in a cluster 220 located at a depth 1010 of at least two below the root on the path; focusing 1416 a topic-directed filter 310 of the corpus on documents in a cluster 220 located at a depth 1010 of at least two below the root on the path; or focusing 1416 a topic-directed analysis 312 of the corpus on documents in a cluster 220 located at a depth 1010 of at least two below the root on the path.

In some embodiments, upon execution the corpus processing tool 232 instructions 116 utilize 1110 the cluster hierarchy to control 1112 summarizing 314 by: selecting 1414 multiple documents 132 of a cluster 220 which are within a specified distance 1038 of the cluster's centroid 216 as representative documents; and employing a language model 134 to generate 1436 a summary 1032 from the multiple documents.

TCH Processes (a.k.a. Methods)

Processes (which are also referred to as “methods” in the legal sense of that word) are illustrated in various ways herein, both in text and in drawing figures. FIGS. 11 to 14 each illustrate a family of TCH methods 1100, 1200, 1300, and 1400 respectively, which are performed or assisted by some enhanced systems, such as some systems 202 or another functionality enhanced system as taught herein. Method families 1100, 1200, and 1300 are each a proper subset of method family 1400. Moreover, activities are identified in FIGS. 1 to 10 as explicit or implicit method steps are likewise incorporated into method 1400, e.g., specifying a termination condition 224, setting one or more of the thresholds 1008, 1012, or 1062, setting a limitation condition 1050, and so on. Also, steps that are not expressly tied herein to a particular reference number are not thereby excluded from method 1400. These diagrams and flowcharts are merely examples; as noted elsewhere, any operable combination of steps that are disclosed herein may be part of a given embodiment when called out in a claim.

Technical processes shown in the Figures or otherwise disclosed are performed automatically, e.g., by an enhanced system 202, unless otherwise indicated. Related non-claimed processes may also be performed in part automatically and in part manually to the extent action by a human person is implicated, e.g., in some situations a human 104 types text into a user interface. Regardless, no process contemplated as an embodiment herein is entirely manual or purely mental; none of the claimed processes can be performed solely in a human mind or on paper. Any claim interpretation to the contrary is squarely at odds with the present disclosure.

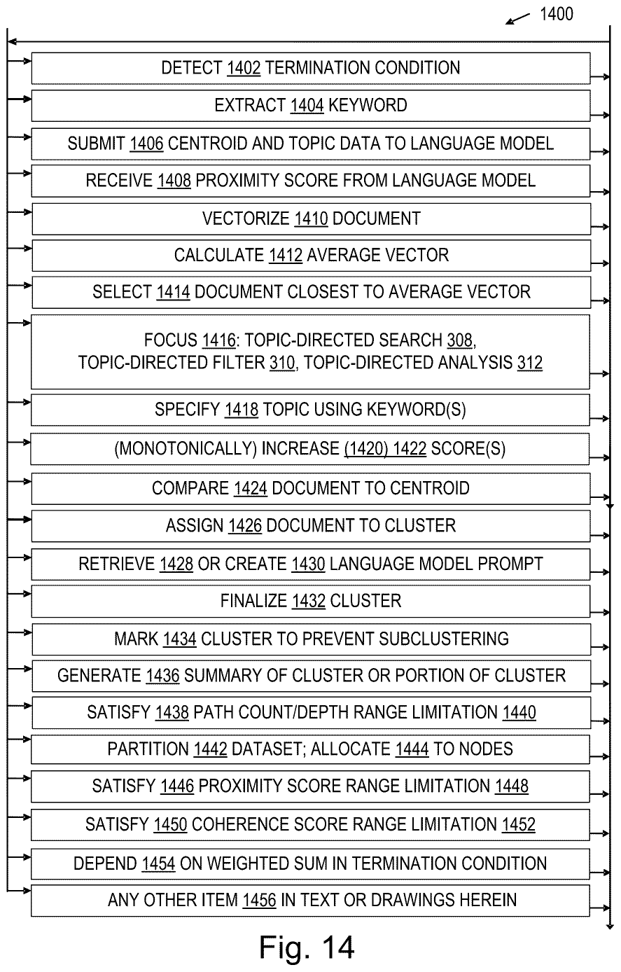

In a given embodiment zero or more illustrated steps of a process may be repeated, perhaps with different parameters or data to operate on. Steps in an embodiment may also be done in a different order than the top-to-bottom order that is laid out in FIG. 14. FIG. 14 is a supplemental portion of the textual and figure drawing examples of embodiments provided herein and the descriptions of embodiments provided herein. In the event of any alleged inconsistency, lack of clarity, or excessive breadth due to an interpretation of FIG. 14, the content of this disclosure shall prevail over that interpretation of FIG. 14.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1400 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 14 to be non-operable, the sequence S is not within the scope of any claim. Any assertion otherwise is contrary to the present disclosure.

Some embodiments provide or utilize a TCH method 1400 which is performed by a computing system. The method includes: obtaining 1102 an initial plurality of clusters 220, each cluster including a data structure 1004 which represents multiple documents 132 of a corpus 130; calculating 1104 a respective centroid 216 for each of the clusters; determining 1106 a respective topic proximity score 226 for each of the centroids, the topic proximity score representing a proximity of the centroid and its corresponding cluster to a specified topic 302; constructing 1108 a cluster hierarchy 208 by recursively specifying 1306 a subcluster 1006, 220 of one of the clusters until a termination condition 224 is detected 1402; and utilizing 1110 at least the cluster hierarchy to control 1112 at least one of: topic-directed searching 308 of the corpus, topic-directed filtering 310 of the corpus, analyzing 312 at least a portion of the corpus, summarizing 314 at least a portion of the corpus, or categorizing 316 at least a portion of the corpus. Some embodiments do not expressly include the obtaining step 1102.

In some embodiments, constructing 1108 a cluster hierarchy includes ranking 1302 two clusters according to at least the topic proximity scores of the respective centroids of the two clusters; and prioritizing 1304 subclustering 1306 of the cluster which is ranked 1016 as more topic proximate (closer).

In some embodiments, the termination condition 224 includes at least one of: a remoteness score threshold 1054, a topic proximity score threshold 1002, a maximum depth 1012 allowed for the cluster hierarchy, a cluster coherence threshold 1008 of a cluster coherence score 228 representing similarity 1034 between documents 132, or a cluster incoherence threshold 1062.

In some embodiments, the method 1400 includes determining 1106 multiple topic proximity scores for each of the centroids 216, each topic proximity score representing a topic proximity of the centroid to a respective specified topic 302; and the termination condition 224 is computed at least in part from the multiple topic proximity scores.

In some embodiments, determining 1106 the respective topic proximity score 226 for a centroid 216 includes: submitting 1406 to a language model 134 a description 1018 of the centroid and a description 1020 of the topic, with a prompt 1028 to produce the topic proximity score; and in response receiving 1408 the topic proximity score from the language model.

In some embodiments, calculating 1104 the respective centroid 216 of a cluster 220 includes at least one of: calculating 1412 an average vector 1022 of embedding vector representations 1026 of a plurality of documents 132 of the cluster; or selecting 1414 a document 132 of the cluster whose embedding vector representation 1026 is nearest the average vector 1022.

With vector embedding technology, words (alone or in phrases or larger sets) are vectorized 1410, such that semantically similar words correspond to nearby vectors in a vector space under cosine similarity or another metric. For example, a vector for “horse” would be closer to vectors for “foal”, “Secretariat”, “thoroughbred”, “Appaloosa”, and “mule” than it would be to a vector for “quantum computer”. Content that is semantically related to “horse” can thus be identified and retrieved even when that content does not contain the word “horse” itself. However, generating and comparing the vectors requires significant computational power, and nearby vectors do not necessarily give accurate results, e.g., in scenarios involving product names or jargon. Understanding why a particular result was returned by a vector-based search is also less clear in many cases than with keyword-based search results.

### TCH Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, is configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing TCH functionality 204 as disclosed herein. The Figures thus help illustrate configured storage media embodiments and process (a.k.a. method) embodiments, as well as system and process embodiments. In particular, any of the method steps illustrated in FIGS. 11 to 14, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a TCH method 1400. This method 1400 includes: obtaining 1102 an initial plurality of clusters, each cluster including a data structure which represents multiple documents of a corpus; calculating 1104 a respective centroid of each of the clusters; determining 1106 a respective topic proximity score for each of the centroids, the topic proximity score representing a proximity of the centroid and its corresponding cluster to a specified topic; constructing 1108 an unbalanced cluster hierarchy by recursive subclustering 1306 until a termination condition is detected 1402, the termination condition dependent on at least one of: a topic proximity score, or a cluster coherence score; and utilizing 1110 at least the cluster hierarchy to control 1112 at least one of: topic-directed searching 308 of the corpus, topic-directed filtering 310 of the corpus, analyzing 312 at least a portion of the corpus, summarizing 314 at least a portion of the corpus, or categorizing 316 at least a portion of the corpus.

In some embodiments, after recursive subclustering is terminated or ruled out for each cluster in the initial plurality of clusters, the unbalanced cluster hierarchy satisfies 1438 at least one of the following limitations 1440: the unbalanced cluster hierarchy 208 includes at least two and not more than seven paths 1024 constructed by recursive subclustering 1306; or a longest path 1024 constructed by recursive subclustering 1306 in the unbalanced cluster hierarchy 208 has a depth 1010 from a root 402 downward of at least two and not more than five clusters.

In some embodiments, after recursive subclustering is terminated or ruled out for each cluster in the initial plurality of clusters, a leaf cluster 1040, 220 on a path 1024 constructed by recursive subclustering 1306 in the unbalanced cluster hierarchy satisfies 1446 or 1450 at least one of the limitations 1448 or 1452: the leaf cluster has a topic proximity score 226 corresponding to a value greater than 0.8 on a scale of 0.0 to 1.0, and no cluster in the initial plurality has a topic proximity score corresponding to a value greater than 0.5 on a scale of 0.0 to 1.0; or the leaf cluster has a cluster coherence score 228 corresponding to a value greater than 0.7 on a scale of 0.0 to 1.0, and no cluster in the initial plurality has a cluster coherence score corresponding to a value greater than 0.4 on a scale of 0.0 to 1.0.

In some embodiments, the topic 302 is specified 1418 by at least two keywords 1052, or a cluster 220 constructed by recursive subclustering 1306 is summarized 314 by at least two keywords, or both.

In some embodiments, the termination condition 224 is dependent 1454 on at least a weighted sum 1048 of respective topic proximity scores 226 for at least two topics 302.

### Additional Observations on TCH

Support for the discussion of TCH functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

Some embodiments taught herein provide or utilize a method for concept specific categorization, which includes calculating document cluster centroids, scoring the centroids for proximity to a topic, and drilling into (i.e., subclustering) the clusters whose topic proximity is above a threshold, thereby producing an unbalanced cluster hierarchy with longer paths that correlate to greater topic proximity or greater cluster cohesion or both. Some variations or refinements include: getting the topic proximity score for the cluster from a language model (e.g., LLM), terminating subclustering when a topic proximity threshold is passed, terminating subclustering when a maximum depth in the hierarchy is reached, terminating subclustering when a cluster cohesion threshold is passed, using multiple topic proximity scores for a given cluster for respective multiple topics (a.k.a. domains of interest), and utilizing a language model to generate summaries based on representative documents within each cluster.

Some embodiments cluster data items (e.g., emails, word processor documents, spreadsheet documents, database records, etc.) according to a received topic (e.g., security, legal, etc.). One embodiment first generates primary clusters from the dataset and then uses an LLM-guided drill-in strategy on user-specified domains. In each iteration, the LLM evaluates cluster topic proximity to determine which clusters to continue subdividing and which to finalize early, avoiding noise from unrelated domains. In some, a user prompt indicates target information requested. Some embodiments use the LLM to determine clusters of data that are more proximate to the user prompt. Some embodiments stop subclustering of data that is not topic proximate, e.g., based on a stopping formula 224.

Some embodiments perform categorization through hierarchical clustering which is guided by LLM-generated cluster topic proximity scores that rank 1016 clusters for drill-in (subclustering) and also permit or prevent subclustering. Subclustering stop conditions depend on, e.g., a combination of cluster proximity to specified topics, weights assigned to each topic, a maximum permitted depth in the cluster hierarchy, and a cluster's coherence as reflected in the similarity of documents within the cluster to one another.

Some embodiments provide or utilize a method 1400 for concept specific categorization. In legal investigation, Data Science Investigation (DSI), and other fields (a.k.a. application areas), managing and analyzing large datasets presents significant challenges. Some categorization methods segment data into arbitrary groups, which detrimentally limits user control and reduces efficiency in identifying proximity topics. Some categorization methods which use Large Language Models (LLMs) lack flexibility and stability, e.g., by frequently focusing on a single dominant topic within a cluster even when multiple distinct topics are present.

Some embodiments taught herein address these limitations by providing an approach that has the strengths of both traditional techniques and LLM-based categorization techniques. Some embodiments dynamically generate categories while guided by LLMs, helping ensure the categories are balanced and unbiased. If instability or excessive topic variation is detected within a cluster, additional techniques are applied to refine and subdivide it further. This comprehensive method provides a more accurate and detailed representation of the dataset, enhancing the ability to identify and analyze pertinent information efficiently.

Some embodiments provide or utilize Adaptive Depth and Bias in Sub-Clustering, which adjusts subclustering based on topic proximity scores, emphasizing high-interest clusters to achieve domain-specific granularity while minimizing unnecessary depth in unrelated clusters.

Some embodiments provide or utilize Ranking-Driven Prioritization, which uses LLM-generated topic proximity ranking 1016 to prioritize clusters for subclustering, enabling dynamic bias toward high-impact clusters.

Some embodiments provide or utilize an Intelligent Stopping Mechanism, which incorporates an LLM-driven topic proximity threshold that determines when to finalize clusters, achieving the required granularity efficiently by stopping early for low-interest clusters.

Some embodiments provide or utilize Incremental Semantic Similarity Classification, whereby at each stage the subclustering uses semantic similarity to refine document assignment, helping to ensure high precision as clusters become increasingly 1422 specialized.

Some embodiments provide or utilize the following workflow. Initial Clustering and Centroid Calculation includes Broad Clustering and Calculation of Initial Centroids. These embodiments use an initial clustering method (e.g., Mini-Batch K-means) to generate broad clusters, allowing for a general separation of topics across all domains in the corpus. Then these embodiments compute centroids for each high-level cluster, summarizing the core of each cluster as a basis for LLM evaluation.

Next, LLM-Based Cluster Topic Proximity Evaluation and Ranking occurs, which includes Cluster Topic Proximity Evaluation, Ranking with Topic Proximity Scores, and Topic Proximity Thresholds for Priority Clusters. These embodiments use an LLM to evaluate the proximity of each cluster centroid to the target domain 302 (e.g., security, patents, or legal). These embodiments also assign topic proximity scores to clusters based on LLM feedback, ranking clusters in order of importance for drill-in (i.e., subclustering). These embodiments use a threshold to identify clusters eligible for further drill-in, helping to ensure that only clusters above the threshold undergo additional subclustering.

Next, Bias-Driven, Depth-Controlled Subclustering occurs, which includes Priority Sub-Clustering for High-Ranking Clusters, Dynamic Depth Control Based on Ranking, and Iterative LLM Re-Evaluation. These embodiments apply subclustering to high-ranking clusters, introducing a depth bias that prioritizes high-proximity clusters to receive more drill-in while stopping early for clusters below the topic proximity threshold. These embodiments also adjust subclustering depth dynamically, with high-ranking clusters allowed deeper granularity and low-ranking clusters finalized with minimal subdivisions. After each subclustering iteration, these embodiments use the LLM to re-evaluate subcluster centroids, adjusting topic proximity scores and rankings accordingly to guide the next round of sub-clustering.

Some embodiments employ an Iterative Stopping Mechanism for Cluster Finalization. An example is an LLM-Based Stopping Criterion. Some embodiments set a stopping condition based on topic proximity scores, depth limits, or a predefined granularity threshold. When a cluster's topic proximity or granularity requirement is met, these embodiments finalize it without further subclustering.

Some embodiments define a stopping condition F(C) for each cluster C as follows:

$$F ( C ) = ( {\sum }_{d = 1}^{D} {w}_{d} \cdot {R}_{d} ( C ) ) \times ( 1 - \frac{G ( C )}{{G}_{max}} ) \times S ( C )$$

where:
D is the total number of user-defined domains 302 of interest (specified topics 302)
R_{d}(C) is the topic proximity 226 of cluster C (determined by an LLM or a topic proximity function)
w_{d} is the weighted sum 1048 weight assigned to domain d, reflecting its importance among other domains, with

$${Σ}_{d = 1}^{D} {w}_{d} = 1$$

G(C) is the current depth 1010 of subclustering for cluster C
Gₘₐₓ is the maximum granularity depth 1010 allowed for subclustering based on domain needs
S(C) is the inter-document similarity within C, a cluster coherence score 228

Within the calculation of stopping condition F(C), an Aggregate Topic Proximity term (sum over domains of domain weight times cluster topic proximity) combines topic proximity scores across domains, weighted by their importance. A Granularity Depth term (one minus current depth over max depth) reduces the stopping score F(C) as the cluster goes deeper, helping to ensure that subclustering continues in high-proximity clusters. An Inter-Document Similarity term S(C) represents internal coherence; high similarity means the cluster is more coherent and helps reach a subclustering stopping point. Variations use only two of these three terms (e.g., Aggregate Topic Proximity and Granularity Depth), or use only one of these three terms. In these examples, the Stopping Condition 224 is defined to operate such that:
If F(C)≥T, then stop sub-clustering for cluster C.
If F(C)<T, continue sub-clustering for cluster C.

Some embodiments perform Semantic Similarity-Based Document Assignment which includes Cluster Embeddings Calculations for Finalized Clusters, Incremental Classification with Similarity Scoring, and Threshold-Based Assignment. For each finalized cluster, these embodiments compute a centroid or representative embedding to serve as an anchor for semantic similarity classification. These embodiments assign documents to clusters incrementally, using semantic similarity to compare documents with cluster centroids to help ensure each document aligns with the most proximate (closest) cluster. These embodiments apply a similarity threshold to avoid misclassification, helping to ensure that documents classified into clusters align with high topic proximity and specificity for the target domain.

Some embodiments perform Final Summarization and Interpretability by using the LLM to generate summaries based on representative documents within each cluster, focusing on high-frequency keywords and unique terms that capture the essence of each final cluster.

In some embodiments, instead of uniformly drilling into each cluster, an approach employing Topic Proximity Based Depth and Ranking Bias uniquely biases subclustering depth according to LLM-ranked topic proximity, achieving domain-focused granularity.

In some embodiments, LLM-Driven Adaptive Subclustering provides dynamic depth control based on topic proximity rankings, which allows these embodiments to stop subclustering early for non-proximate clusters, thereby reducing cluster count and noise.

In some embodiments, by continuously re-evaluating clusters, the LLM fine-tunes topic proximity rankings, helping to ensure drill-in focus remains current with evolving insights.

More generally, embodiments yield efficient, domain-specific clusters and mitigate noise, addressing the limitations of traditional clustering for specialized domains.

One example of an LLM prompt for evaluating of the cluster topic proximity includes: “I have a clustering of documents and need to evaluate how relevant (that is, proximate) each cluster is to a given topic. Each cluster is represented by the following: Cluster Representation which includes a centroid document that represents the core of the cluster, and a list of top keywords extracted from the cluster; and Topic Definition which includes a description of the topic, outlining its scope and key attributes. Your Task is or each cluster: Analyze the centroid document and top keywords in the context of the topic description. Compute a topic proximity score between 0 and 1, where 0 indicates no topic proximity and 1 indicates complete alignment with the topic. Provide an explanation for the topic proximity score, covering the following: How well the centroid document aligns with the topic description, The overlap or thematic similarity between the top keywords and the topic, and Any gaps or mismatches that justify a lower score.”

### An Example Input Includes the Following.

Centroid Document (Short Finance Report): “Recent market analysis reveals a significant increase in cybersecurity investments by financial institutions. Reports indicate that firms are focusing on mitigating risks associated with fraud detection and real-time transaction monitoring. Additionally, the adoption of blockchain technology is being explored as a method to secure financial data.”

Top Keywords: [“cybersecurity,” “fraud detection,” “transaction monitoring,” “blockchain,” “risk mitigation,” “financial data,” “market analysis” ]

User-Given Topic Description: “Security detection methods encompass techniques and technologies designed to identify, prevent, and respond to unauthorized access or malicious activities. These methods often involve real-time monitoring, anomaly detection, and the use of machine learning algorithms to analyze behavior patterns for potential threats.”

In this example, the LLM would produce output along the following lines. Topic Proximity Score: 0.85. Explanation: Alignment with the Topic: The centroid document discusses cybersecurity investments, fraud detection, and real-time transaction monitoring, all of which directly relate to security detection methods. Blockchain is mentioned as a secure method for financial data, adding another layer of topic proximity to the topic. Keyword Overlap: Keywords such as “cybersecurity,” “fraud detection,” and “transaction monitoring” strongly align with the user-given topic, which emphasizes detection techniques and real-time monitoring. While terms like “market analysis” and “financial data” are less proximate, they do not detract significantly from the overall alignment. Gaps: The document does not explicitly address anomaly detection or machine learning, which are important aspects of the user-given topic. However, the focus on real-time monitoring and fraud detection compensates for this gap, maintaining high topic proximity. The overall alignment between the financial report and the topic of security detection methods is strong, with minor gaps that slightly lower the perfect score.”

Example pseudo code consistent with some embodiments follows.

```
# Evaluate a cluster's weighted topic proximity score given a list of
domains function evaluate_cluster_topic_proximity (cluster, domains,
llm):
# cluster: a single cluster of documents with a centroid and top keywords
# domains: List of user-defined domains of interest (with descriptions and
weights)
# llm: Function or API for LLM-based evaluation
  total_weighted_topic_proximity = 0
  # Extract cluster information
  centroid_doc = cluster[‘centroid_document’]
  keywords = cluster[‘top_keywords’]
  for domain in domains:
    # Extract domain information
    domain_description = domain[‘description’]
    domain_weight = domain[‘weight’] # Weight of this domain
    # Step 1: Use LLM to evaluate topic proximity
    input_prompt = f“““
      I have a cluster represented by the following:
      - Centroid Document: {centroid_doc}
      - Keywords: {keywords}
      I also have a target domain defined as:
      - Domain Description: {domain_description}
      Please evaluate how close the cluster is to the domain on a scale of
0 to 1.
      Provide an explanation covering alignment between the centroid,
keywords, and the domain description.
    ”””
    topic_proximity_score, explanation = llm(input_prompt)
    # Step 2: Add weighted topic proximity for this domain
    weighted_topic_proximity = topic_proximity_score *
    domain_weight
    total_weighted_topic_proximity += weighted_topic_proximity
  return total_weighted_topic_proximity
#Evaluate the coherence of a cluster by sampling random document pairs
and averaging their distances.
function evaluate_cluster_coherence(documents, embedding_function,
num_samples):
#documents: List of documents in the cluster.
#embedding_function: Function to generate embeddings for documents.
#num_samples: Number of random pairs to sample.
  # Step 1: Generate embeddings for all documents
  embeddings = embedding_function(documents)
  # Step 2: Initialize variables
  total_distance = 0
  num_pairs = 0
  document_indices = indices(documents) # Get indices of documents
  # Step 3: Randomly sample document pairs
  for i in range(num_samples):
    # Randomly sample two document indices
    doc1, doc2 = random_sample(document_indices, 2)
```

One of skill further informed by the teachings herein will recognize several benefits and advantages of various embodiments.

For example, embodiments improve security because less human review and eyes on sensitive content are required using TCH classification.

TCH functionality 204 provides a highly efficient method for handling large-scale data clustering by dynamically identifying and focusing on clusters that align with a user's specific domain of interest 302. Clusters that do not meet the threshold 1954 of topic proximity are marked as non-essential and remain at a higher, coarser level of categorization. This selective approach reduces computational overhead and processing time, as the system 202 avoids the extra effort and cost of producing fine-grained sub-clusters in corpus portions that offer limited value to the user.

TCH functionality 204 significantly enhances the effectiveness of document clustering by employing a finer granularity in segmenting and grouping content. Instead of relying on broad, high-level clusters that obscure important nuances, the system 202 organizes documents into smaller, more focused clusters. Such micro-level clustering allows for the identification of subtle relationships, themes, or keywords that otherwise go undetected in a coarser-grained approach.

TCH functionality 204 accelerates processing 230 and reduces computational overhead by identifying and halting the analysis of clusters that are deemed remote at an early stage. Through a continual assessment of each cluster's potential value—based on factors such as matching criteria, thematic alignment, or user-defined thresholds—the system 202 dynamically determines which clusters warrant deeper investigation. Once a cluster is flagged as non-essential, the system 202 discontinues further processing on that cluster, preventing the expenditure of additional resources on refining or subdividing it. Accuracy and topic proximity are improved thru the iterative clustering and training process.

Some embodiments employ a distributed clustering framework to evenly balance processing tasks across multiple nodes or servers. Rather than concentrating data analysis on a single machine, they partition large data sets and allocate them to different nodes. This parallelization effectively prevents any single node from becoming a bottleneck, improving both speed and scalability as the volume of incoming data grows.

Unlike some approaches, embodiments taught herein dynamically assess each cluster's topic proximity early in the processing 230. Clusters that do not meet a threshold of importance are not subjected to deeper subclustering, thereby conserving computational effort and preventing the analysis pipeline from becoming overloaded by low-value or unrelated content. Also, by distributing the clustering workload across multiple nodes, the functionality 204 eliminates the risk of any one machine becoming a bottleneck or point of failure. This approach not only boosts speed and scalability but also makes the overall system 202 more resilient to hardware or network issues.

Although security investigation and legal investigation are noted as example, functionality 204 would also be beneficially applied to the analysis and clustering of documents in medical, financial, and manufacturing settings, enabling efficient data organization, quicker insights, and more precise decision-making across these diverse industries.

### Machine Learning Models, Including Language Models

A language model or other machine learning model within or utilized by an enhanced system 202 is not necessarily a large language model (LLM) in every embodiment, but it is an LLM in some embodiments. For present purposes, a language model is “large” if it has at least a billion parameters. For example, GPT-2 (OpenAI), MegatronLM (NVIDIA), T5 (Google), Turing-NLG (Microsoft), GPT-3 (OpenAI), GPT-3.5 (OpenAI), GPT-4 (OpenAI), and LLaMA versions (Meta AI) are each a large language model (LLM) for purposes of the present disclosure, regardless of any definitions to the contrary that may be present in the industry. Some examples of models include language models which are large language models, large language models (LLMs), multimodal language models, and foundation models.

Language model stability is a consideration in some embodiments and some scenarios. Instability leads to inconsistency in language model responses to prompts. Language model stability is sometimes dependent on language model parameters. Some different large language models have different stability parameters, and some exhibit different variability between answers to the same question even while using the same stability parameters. Some models are stabilized by adjusting parameters such as temperature, frequency penalty, presence penalty, or nucleus sampling, and also or instead by constraining the queries sent to a given instance of the model. In some scenarios, model performance is optimized by use of suitable training data, fine-tuning, prompt engineering, or a combination thereof.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as calculating a topic proximity score without employing human senses or human actions, ranking items without employing human senses or human actions, searching documents without employing human senses or human actions, submitting data to a language model without employing human senses or human actions, and receiving data from a language model without employing human senses or human actions, and many others, which are each an activity deeply rooted in computing technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., language models, rankers, topic proximity score calculators, APIs, and various particular sets of instructions 116 executable by processors 110. None of these are mental concepts or present merely on paper.

In addition, some of the technical effects discussed include, e.g., increased accuracy, increased effectiveness, and increased efficiency, relative to other approaches. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that the operations performed by functionality 204, and other computational activities described herein are each a technical activity which cannot be performed mentally at all, because the mechanisms in question lack I/O devices that would allow a human to somehow “read” or “write” values within the computing system as described. Hence, computing technology operational improvements such as the various examples of functionality 204 described herein are improvements to computing technology. People manifestly lack the speed and the digital communication and computation capabilities which are required to perform functionality 204 operations as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as a search tool, filter tool, analysis tool, summarization tool, or categorization tool. The foregoing are examples, not a comprehensive list of all potential practical applications of the present disclosure's teachings.

Many embodiments are suitable for implementation in a single device, but some embodiments also span multiple devices.

Some embodiments described herein may be viewed by some people in a broader context. For instance, concepts such as efficiency, reliability, redundancy, or waste may be deemed pertinent to a particular embodiment. However, it does not follow from the availability of a broad context that exclusive rights are being sought herein for abstract ideas; they are not. In particular, no claim is made to search activities generally, or categorization activities generally, as opposed to the particular functionality 204 methods, systems, and devices described and claimed in the eventual final claims based on the present disclosure.

Rather, the present disclosure is focused on providing appropriately specific embodiments whose technical effects fully or partially solve particular technical problems noted herein, e.g., in connection with one of the marker phrases “how to”, “problem”, or “challenge”, or otherwise apparent to one of skill in the art. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, software, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, examples, operating environments, tools, peripherals, process flows, identifiers, naming conventions, notations, control flows, data flows, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the pertinent art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human action, but does allow coverage of computational action which is performed in response to human action. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Functionality 204 operations discussed herein (whether recited expressly in the Figures or not), are understood to be inherently non-human. A human mind cannot interface directly with a computing device to perform the functionality 204 steps taught herein. This would all be well understood by persons of skill in the art in view of the present disclosure. Moreover, one of skill understands that functionality 204 cannot be implemented merely with conventional tools and steps, because actual implementation requires the use of teachings which were first provided in the present disclosure, e.g., teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends computationally on at least X, and may also depend computationally on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, with regard to a destination or object, may involve intervening action, such as any action recited in this disclosure or inherent in a step recited in this disclosure, yet still be understood as being performed directly by or on behalf of the party of interest. Example verbs listed herein may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, any and all of the ascertaining, detecting, and determining described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims herein is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A distinction in this example is that a computing system 102 contains one or more machines 101, whereas reference numeral 101 refers to a single machine, e.g., a single laptop, a single smartphone, a single workstation, a single Internet of Things device, etc. However, reference numerals for more general categories are often omitted herein for better readability, particularly when one of skill would acknowledge that the more general category encompasses a more specific category whose reference numeral is recited.

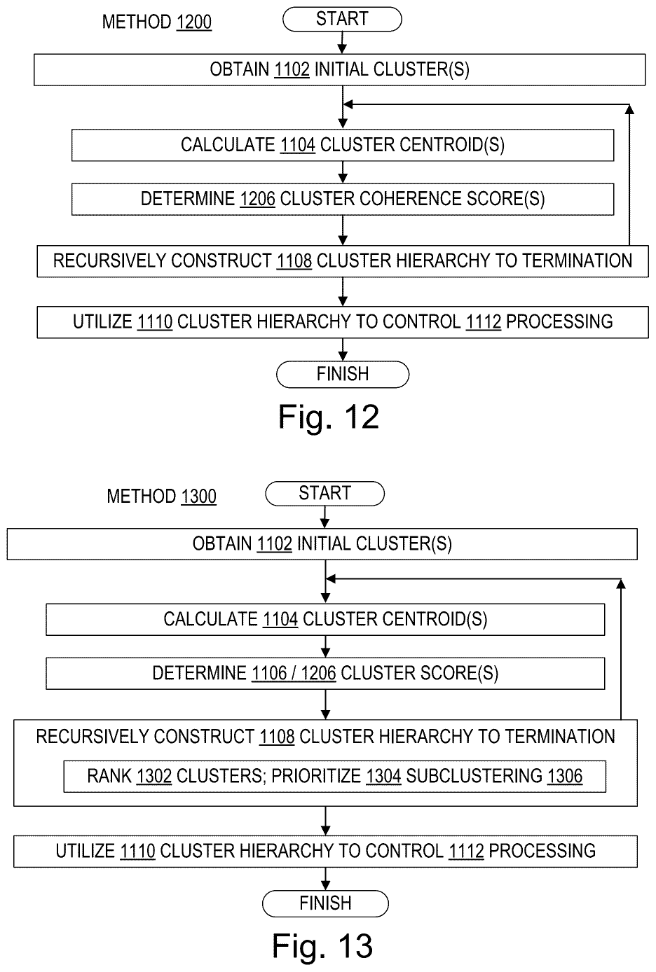

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, web browsers, CIDFP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
136 interface, e.g., network interface card, API, user interface, language model interface, or other mechanism by or through which separable items communicate in a computing system, where examples of separable include physically separable, separately compilable, separately installable, or separably replaceable without loss of functionality
202 enhanced system, i.e., system 102 enhanced with functionality 204 as taught herein
204 TCH functionality (also referred to as functionality 204), e.g., a mechanism which performs or is configured to perform steps 1108, 1302, 1304, and 1306, or any mechanism which performs or is configured to perform a sequence of cluster hierarchy construction activities or classification activities or both, first disclosed herein, or to perform a novel method 1400 first disclosed herein
304 one or more of: topic proximity score or coherence score; digital
306 computational result of TCH utilization
1000 toplical clustering generally; computational
1100 flowchart; 1100 also refers to TCH methods that are illustrated by or consistent with the FIG. 11 flowchart or any variation of the FIG. 11 flowchart described herein
1200 flowchart; 1200 also refers to TCH methods that are illustrated by or consistent with the FIG. 12 flowchart or any variation of the FIG. 12 flowchart described herein
1300 flowchart; 1300 also refers to TCH methods that are illustrated by or consistent with the FIG. 13 flowchart or any variation of the FIG. 13 flowchart described herein
1400 flowchart; 1400 also refers to TCH methods that are illustrated by or consistent with the FIG. 14 flowchart, which incorporates the flowcharts of FIG. 11 through FIG. 13, the steps implicit or express in FIGS. 1 through 10, and all other steps taught herein, or methods that are illustrated by or consistent with any variation of the FIG. 14 flowchart described herein; all TCH method steps are computational or otherwise artificial, not human activity
1456 any step or item discussed in the present disclosure that has not been assigned some other reference numeral; 1456 may thus be shown expressly as a reference numeral for various steps or items or both, and may properly be inserted as a reference numeral (in the current disclosure or any subsequent patent application which claims priority to the current disclosure) for various steps or items or both without thereby adding new matter

### CONCLUSION

Some embodiments construct 210 a topical cluster hierarchy (TCH) 208 by recursive subclustering 1306 of document 132 clusters 220 until a termination condition 224 is detected 1402. The clusters have centroids 216 of topic proximity 212 with respect to at least one user-specified topic 302. Subclustering starts after a threshold 1054 of minimal cluster topic proximity or a threshold 1062 of minimal cluster coherence 1064 are met, thus avoiding processing of low-utility clusters. Subclustering terminates when sufficient topic proximity, coherence, or cluster depth 1010 is reached. A tool 122 utilizes the TCH to control topic-directed searching 308, topic-directed filtering 310, analyzing 312, summarizing 314, or categorizing 316, of documents 132.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some examples, the teachings herein are not limited to use in technology supplied or administered by Microsoft. Under a suitable license, for example, the present teachings could be embodied in products or services provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, topologies, system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such a standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

1. A method performed by a computing system, the method comprising:
calculating a respective centroid of each of a plurality of clusters, each cluster comprising a data structure which represents multiple documents of a corpus;
determining a respective topic proximity score for each of the centroids, the topic proximity score representing a proximity of the centroid and its corresponding cluster to a specified topic;
constructing a cluster hierarchy by recursively specifying a subcluster of one of the clusters until a termination condition is detected; and
utilizing at least the cluster hierarchy to control at least one of: topic-directed searching of the corpus, topic-directed filtering of the corpus, analyzing at least a portion of the corpus, summarizing at least a portion of the corpus, or categorizing at least a portion of the corpus.

2. The method of claim 1, wherein:
constructing a cluster hierarchy comprises ranking two clusters according to at least the topic proximity scores of the respective centroids of the two clusters; and
prioritizing subclustering of the cluster which is ranked as more topic proximate.

3. The method of claim 1, wherein the termination condition comprises at least one of: a remoteness score threshold, a topic proximity score threshold, a maximum depth allowed for the cluster hierarchy, a cluster coherence threshold of a cluster coherence score representing similarity between documents, or a cluster incoherence threshold.

4. The method of claim 1, wherein:
the method comprises determining multiple topic proximity scores for each of the centroids, each topic proximity score representing a proximity of the centroid to a respective specified topic; and
the termination condition is computed at least in part from the multiple topic proximity scores.

5. The method of claim 1, wherein determining the respective topic proximity score for a centroid comprises:
submitting to a language model a description of the centroid and a description of the topic, with a prompt to produce the topic proximity score; and
in response receiving the topic proximity score from the language model.

6. The method of claim 1, wherein calculating the respective centroid of a cluster comprises at least one of:
calculating an average vector of embedding vector representations of a plurality of documents of the cluster; or
selecting a document of the cluster whose embedding vector representation is nearest the average vector.

7. A computing system, comprising:
a digital memory;
a processor in operable communication with the digital memory;
a cluster obtainer comprising instructions which upon execution by the processor obtain an initial plurality of clusters, each cluster comprising a data structure which represents multiple documents of a corpus;
a centroid calculator comprising instructions which upon execution by the processor calculate a respective centroid of each of the clusters;
a topic proximity determiner comprising instructions which upon execution by the processor determine a respective topic proximity score for each of the centroids, the topic proximity score representing a proximity of the centroid to a specified topic;
a hierarchy constructor comprising instructions which upon execution by the processor constructs a cluster hierarchy by recursively specifying a subcluster of one of the clusters until a termination condition is detected; and
a corpus processing tool comprising instructions which upon execution by the processor utilize at least the cluster hierarchy to control at least one of: topic-directed searching of the corpus, topic-directed filtering of the corpus, analyzing at least a portion of the corpus,
summarizing at least a portion of the corpus, or categorizing at least a portion of the corpus.

8. The computing system of claim 7, further comprising the cluster hierarchy residing in the digital memory, wherein the cluster hierarchy is unbalanced, the cluster hierarchy includes a path from a leaf cluster to a root, the root is a parent of the initial plurality of clusters, the path includes the leaf cluster and at least one ancestor of the leaf cluster below the root, and the path satisfies at least one of:
topic proximity scores monotonically increase along the path, and the leaf cluster's topic proximity score is greater than the topic proximity score of the cluster that is closest to the root on the path; or
cluster coherence scores monotonically increase along the path, and the leaf cluster's cluster coherence score is greater than the cluster coherence score of the cluster that is closest to the root on the path.

9. The computing system of claim 7, comprising instructions which upon execution by the processor incrementally assign a document of the corpus to a cluster after comparing the document to the centroid of the cluster under a semantic similarity metric.

10. The computing system of claim 7, wherein the topic proximity determiner:
comprises at least one of: a language model, or an interface to a language model;
upon execution retrieves or creates a language model prompt which comprises or describes the cluster centroid, comprises or describes a keyword extracted from the cluster, and comprises a description of the topic; and
upon execution submits the prompt to the language model, and in response receives the topic proximity score from the language model.

11. The computing system of claim 7, wherein the computing system comprises multiple processing nodes, and further comprises instructions which upon execution by the processor partition the corpus into multiple corpus portions, and allocate a plurality of the corpus portions to respective processing nodes.

12. The computing system of claim 7, wherein upon execution the corpus processing tool instructions:
subcluster a first cluster whose topic proximity score is less than a specified topic proximity threshold and greater than or equal to a specified remoteness threshold; and
finalize a second cluster whose topic proximity score is greater than or equal the specified topic proximity threshold without subclustering the second cluster, wherein finalizing comprises marking the second cluster to prevent subclustering the second cluster.

13. The computing system of claim 12, wherein finalizing further comprises generating a summary of the second cluster.

14. The computing system of claim 7, further comprising the cluster hierarchy residing in the digital memory, wherein the cluster hierarchy is unbalanced, the cluster hierarchy includes a path from a leaf cluster to a root, the root is a parent of the initial plurality of clusters, the path includes the leaf cluster and at least one ancestor of the leaf cluster below the root, and upon execution the corpus processing tool instructions utilize the cluster hierarchy by at least one of:
focusing a topic-directed search of the corpus on documents in a cluster located at a depth of at least two below the root on the path;
focusing a topic-directed filter of the corpus on documents in a cluster located at a depth of at least two below the root on the path; or
focusing a topic-directed analysis of the corpus on documents in a cluster located at a depth of at least two below the root on the path.

15. The computing system of claim 7, wherein upon execution the corpus processing tool instructions utilize the cluster hierarchy to control summarizing by:
selecting multiple documents of a cluster which are within a specified distance of the cluster's centroid as representative documents; and
employing a language model to generate a summary from the multiple documents.

16. A computer-readable storage medium configured with data and instructions which upon execution by a processor of a computing system perform a method comprising:
calculating a respective centroid of each of an initial plurality of clusters, each cluster comprising a data structure which represents multiple documents of a corpus;
determining a respective topic proximity score for each of the centroids, the topic proximity score representing a proximity of the centroid and its corresponding cluster to a specified topic;
constructing an unbalanced cluster hierarchy by recursive subclustering until a termination condition is detected, the termination condition dependent on at least one of: a topic proximity score, or a cluster coherence score; and
utilizing at least the cluster hierarchy to control at least one of: topic-directed searching of the corpus, topic-directed filtering of the corpus, analyzing at least a portion of the corpus, summarizing at least a portion of the corpus, or categorizing at least a portion of the corpus.

17. The computer-readable storage medium of claim 16, wherein after recursive subclustering is terminated or ruled out for each cluster in the initial plurality of clusters, the unbalanced cluster hierarchy satisfies at least one of:
the unbalanced cluster hierarchy includes at least two and not more than seven paths constructed by recursive subclustering; or
a longest path constructed by recursive subclustering in the unbalanced cluster hierarchy has a depth from a root downward of at least two and not more than five clusters.

18. The computer-readable storage medium of claim 16, wherein after recursive subclustering is terminated or ruled out for each cluster in the initial plurality of clusters, a leaf cluster on a path constructed by recursive subclustering in the unbalanced cluster hierarchy satisfies at least one of:
the leaf cluster has a topic proximity score corresponding to a value greater than 0.8 on a scale of 0.0 to 1.0, and no cluster in the initial plurality has a topic proximity score corresponding to a value greater than 0.5 on a scale of 0.0 to 1.0; or
the leaf cluster has a cluster coherence score corresponding to a value greater than 0.7 on a scale of 0.0 to 1.0, and no cluster in the initial plurality has a cluster coherence score corresponding to a value greater than 0.4 on a scale of 0.0 to 1.0.

19. The computer-readable storage medium of claim 16, wherein the topic is specified by at least two keywords, or a cluster constructed by recursive subclustering is summarized by at least two keywords, or both.

20. The computer-readable storage medium of claim 16, wherein the termination condition is dependent on at least a weighted sum of respective topic proximity scores for at least two topics.
